(19) United States
(12) Patent Application Publication
(10) Pub. No.: US 2018/0150621 A1
(43) Pub. Date: May 31, 2018

(54) PROVISION OF AT LEAST ONE PASSWORD

(71) Applicant: Siemens Aktiengesellschaft, München (DE)

(72) Inventors: Klaus Lukas, München (DE); Elmar Sommer, München (DE)

(21) Appl. No.: 15/573,576

(22) PCT Filed: May 19, 2016
(86) PCT No.: PCT/EP2016/061263

§ 371 Date: Nov. 13, 2017

(30) Foreign Application Priority Data
Jun. 22, 2015 (DE) 10 2015 211 475.9

(51) Int. Cl. G06F 21/31; G06F 21/45; G06F 21/60

(52) U.S. Cl. CPC G06F 21/31; G06F 21/604; G06F 21/45

(57) ABSTRACT

Methods and devices for providing at least one password for a change in state of a device from a first operational state into a second operational state by inputting the password is provided. A number of characters of the password are set in accordance with the duration of the first operating state of the device.

### CROSS-REFERENCE TO RELATED APPLICATIONS

This application claims priority to PCT Application No. PCT/EP2016/061263, having a filing date of May 19, 2016, based off of German application No. DE 102015211475.9 having a filing date of Jun. 22, 2015, the entire contents of both of which are hereby incorporated by reference.

### FIELD OF TECHNOLOGY

The following relates to methods and devices for the provision of at least one password in order to change a device from a first operational state into a second operational state.

### BACKGROUND

Nowadays, inputting passwords often takes place by default to unlock, also referred to as an authentication or login, devices such as milling robots, x-ray devices or smart meters.

Especially in environments where basic security is available through the physical protection of areas, such as industrial facilities, power plants, medical areas in hospitals, higher costs for higher-quality authentication mechanisms, such as chip cards, are often done without. On the other hand, passwords must meet certain minimum requirements so that, in the event of undetected access, there is protection against unauthorized authentication during the “Login” process.

Usually, the minimum requirements are based on criteria, such as the use of special characters, upper and lowercase letters, or with regard to password length. In the case of simple systems, this can be eight characters; in the case of more critical systems, this can, of course, also be 15 characters or more in length.

In conjunction with screensavers/screen-locking mechanisms that lock devices after a short time of inactivity, frequently, the situation arises that, already after a short interruption of work has occurred, the entire password needs to be input again in order to unlock the device. However, this is unfavorable, especially within a time-critical environment if, for example, an operator is supposed to react rapidly to an alarm notification. This is furthermore made more difficult by input systems without a full keyboard, whereby entering a long password is a laborious and error-prone process, for example, in the case of a touch-control screen.

Alternative solutions to login by character input are, for example, more expensive hardware-based solutions such as chip-card authentication with PIN, biometric fingerprint sensors, or contactless chips in order to achieve faster authentication.

In the case of mobile end devices, such as smartphones or tablets, PIN input possibilities have also become established via patterns that must be entered using finger swipes. Since these patterns can be guessed due to the finger residue on the display caused by swiping, the security is hereby reduced in favor of more comfortable authentication.

Also, speech-based authentication has not prevailed due to a high rate of error in critical environments.

### SUMMARY

An aspect relates to describing methods and devices with which quick authentication can be carried out, wherein an appropriate compromise between user comfort and security should exist.

Embodiments of the invention relates to a procedure for the provision of at least one password for changing the state of a device from a first operational state into a second operational state by inputting the password, where a number of characters of the password are set in accordance with the time duration of the first operational state of the device. More preferably, the number of characters can be set to be greater as the time duration increases.

This method has the advantage that the longer the device is in the first operational state or is inactive, the stronger the password is that is required to change the operational state. Stronger in this context means that compromising the password is more cumbersome since, for example, the password has a large number of characters. On the other hand, in the case of a shorter duration of the first operational state, a shorter password is used, whereby the device can change its operational state in a short amount of time with less data volume for the password.

In an embodiment variation of the method, the following steps are carried out:

(a) after successfully inputting the password with a first number of characters, a list with at least one partial password is created, wherein the at least one partial password has a subset of the password's characters and a number of characters of the at least one partial password is less than or equal to the first number,
b) the list provides a lot of passwords for changing the state of the device from the first operational state to the second operational state.

Thereby, the process can be implemented in a simple way with the help of a list that contains the passwords and partial passwords.

Preferably, after a time period of the time duration has expired, whereby the time period represents a span of time after carrying out a modification to the list, one or a plurality of partial passwords are deleted from the list. Hereby, it is ensured that after the time period of the time duration has passed, only the partial passwords/passwords are still available that are available after the time period has expired, since these have a higher level of security than before expiration.

Furthermore, after deleting at least one partial password, the time period can be increased or decreased up until the next modification of the list. By this, the security of the passwords can be adapted to predefined conditions. For example, the time period increases exponentially with the length of that partial password, which has a minimum number of characters under partial passwords contained in the list. In another example, the time period can be reduced with a reduced number of partial passwords remaining in the list if, for example, in the case of prolonged activity of the first operational state, the security of the device should be quickly increased.

An enhancement of this entails a value of the time period being generated at least based on entropy of the same partial password of the list that has the smallest number of characters. By this, not only the length of the partial password, but also its character combination is taken into account. If the entropy of the partial password in question with the shortest length is relatively high because the predictability of the selected character string is complicated—meaning elaborate—, then also the time period can be selected to be larger because the probability of compromising the partial password is less than expected.

Preferably, a value for the time period is set based on a distance or specifying a location, more preferably, a geographical position of the device. By means of this, local security requirements can be taken into account in determining the time period. In this way, a lower value for the time period can be selected in plants where a high level of damage could be caused if manipulated than in plants where less economic damage would be caused if manipulated. This can take place by determining a position based on a GPS reading for example (GPS—Global Positioning System). Furthermore, a distance between the operating personnel of the device can be captured, because the further the operating personnel is from the device, the more inconspicuous attacks on the device can be due to compromising the password. In this case, a greater distance of the operating personnel can require a shorter time period.

A variant of the procedure prevents partial passwords from being deleted from the list once the list contains only a single password. This prevents the list from containing no passwords, and it thus being no longer possible to change the operational state.

Preferably, the list with a plurality of partial passwords is created in such a way that one of the partial passwords with a small number of characters is fully contained in another one of the partial passwords with a greater number of characters than the small number of characters. By means of this, the user must memorize a single password since a partial password can already be recognized when the password is partially entered, if this is available as a partial password in the list. In addition, by means of this, the formation of partial passwords can be considerably simplified and the user must not memorize any password variants. Furthermore, in this case, the user that inputs the password must not remember how the partial passwords, which are not available, are specifically constructed. By this, a simplification of the procedure results.

Preferably, in one variant of the method, the at least one partial password can be saved in the list with the help of a hash-coding method in sequence and in a coded manner. By this, a possibility for manipulating the method is considerably reduced since the partial passwords/passwords are only stored in the list in encrypted form.

The security can be increased further by using the hash-coding method if, when coding the partial password, a random value is furthermore taken into account and the random value is additionally saved in the list. The random value is a so-called “salt”, which is used in the creation of the hash values and prevents pre-calculated hash values from being able to be used for cracking passwords.

Furthermore, embodiments of the invention relates to a device for the provision of at least one password for changing the state of a device from a first operational state into a second operational state by inputting the password, where the one first unit is designed to set a number of characters of the password depending on a time period of the first operational state of the device.

The advantages of the device are similar to those of the method.

Furthermore, the method can have a second unit that is designed in such a way that at least one of the aforementioned method steps can be implemented and executed.

The advantages of the device are similar to those of the method.

### BRIEF DESCRIPTION

Some of the embodiments will be described in detail, with reference to the following figures, wherein like designations denote like members, wherein:

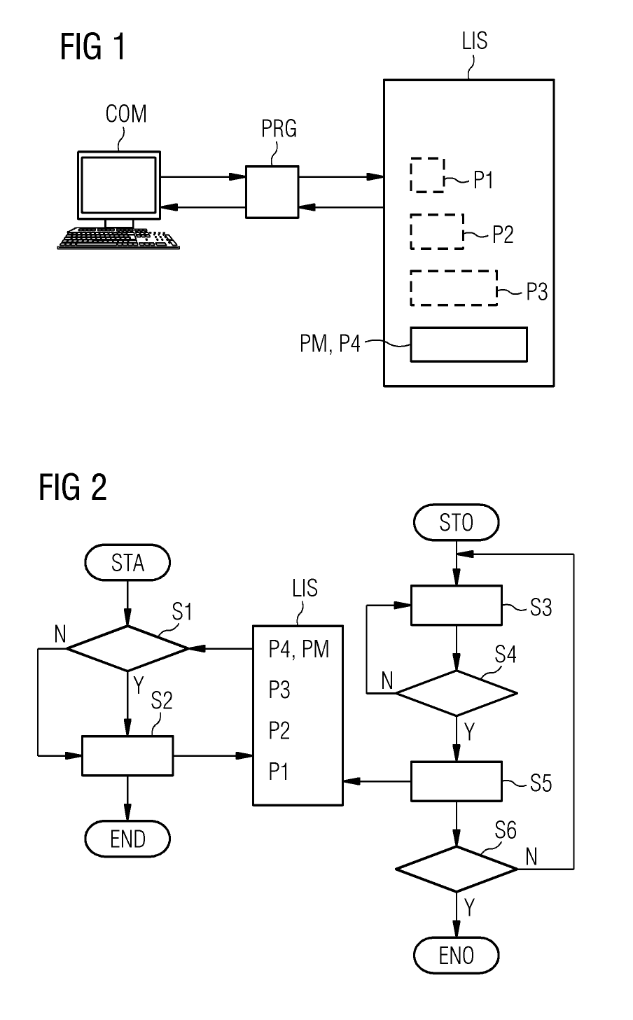

FIG. 1 shows a first exemplary embodiment;

FIG. 2 shows flow diagrams of the first exemplary embodiment; and

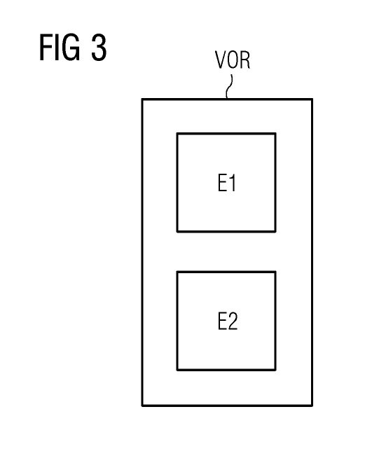

FIG. 3 shows a device for implementing embodiments of the invention

Elements having identical function and effect are provided with the same reference numbers in the figures.

### DETAILED DESCRIPTION

In a first exemplary embodiment, FIG. 1 shows embodiments of the invention using a device in the form of a workstation computer COM. A user works with the workstation computer. In addition, he must initially login at the workstation computer and perform an authentication. For this purpose, he enters his password PM=P4=“a!8m” (the quotations are not part of the password, but are indicated in this description for better readability of passwords). The password comprises a sequence of characters, such as numbers, letters and special characters. The input, verification and the further provision of the password for authentication is controlled by a program PRG, which, for example, is installed on the workstation computer and is being executed there.

After entering the password, the program verifies if it is a valid password or not. In addition, it searches in a list LIS that is saved in a memory. If the password is found in the list, the program changes the state of the workstation computer from a first operational state into a second operational state so that the user can then start his/her own programs. The new operational state blocks access to the operating interface of the workstation computer so that only the password has to be input in this case. In the second operational state, the operational interface is provided to the user for control. In the following, the first operational state is also called an inactive state and the second operational state is called an active state. If the password is not found in the list, the program does not release the screen to the user, meaning the workstation computer remains in its inactive state.

FIG. 2 shows steps to carry out embodiments of the invention in accordance with the first exemplary embodiment. In the center, there is the list LIS, which contains one or a plurality of passwords, by which the workstation computer can be changed into the active state. Initially, the list merely indicates the password in its full length. This is also called a master password since partial passwords can be derived from this at a later time. In the present example, the master password P4, PM indicates four characters, PM=“a!8m”.

FIG. 2 on the left shows a first flow diagram that starts in the starting state STA and then reaches the first state S1. In the first state, S1, it is verified if inputting an entered password has resulted in an admissible password or not. The verification takes place in such a way that the entered password corresponds to one of the passwords that has been stored in the list, meaning an admissible password. If no admissible password is found, the flow diagram goes to an end state END via path N of the flow diagram. If the entered password is identical to one of the passwords of the list, a second state S2 is achieved over path Y, that generates partial passwords P1, P2, P3 with different lengths, meaning with a respectively different number of characters. The second state S2 writes the following partial passwords into the list LIS:

| Partial password | Content | Number of characters |
|---|---|---|
| P1 | a | 1 |
| P2 | a! | 2 |
| P3 | a!8 | 3 |

Each partial password respectively comprises a part of the master password, wherein, however, the respective number of characters is from 1 character to 3 characters, which means smaller than or identical to a number of characters of the master password.

After providing the partial passwords, the flow diagram ends in the end state END.

In order to avoid unauthorized access to the workstation computer, the workplace computer changes its state from the active state to the inactive state after a time span of one minute for example, if no input by the user takes place within this time span. The workstation computer then switches on the screensaver, for example, so that merely one password can be input as part of the login, however, no other entries can take place on the workstation computer.

After transferring from the active state to the inactive state, the flow diagram starts on the right of FIG. 2 with the starting state STO. This state goes immediately into the third state S3, in which a time period TP for the time duration TD is defined. The time period TO defines a time period, after which the list with the passwords and the partial passwords is reduced by one or a plurality of partial passwords. The time duration TD describes the time period, in which the first operational state is active. During the time duration, in several time spans called time periods TP, a list with possible passwords is changed in order to gradually increase security due to increasing a length of the respective admissible password. The time period TP is five minutes for example. Until the expiry of this time period, the user can also use one of the partial passwords, for example P1=“a”, instead of the master password in order to change the workstation computer into the active state quickly and easily.

After defining the time period TP, the state diagram transfers from the third state S3 into the fourth state S4. As long as the time period of 5 minutes has still not lapsed, the fourth state S4 is repeatedly called up over path N. After the time period of five minutes has lapsed, the state diagram changes into the fifth state S5 over path Y. There, one or a plurality of partial passwords are deleted from the list, wherein the same password is deleted that has a lowest number of characters of the partial passwords that are still available in the list. Thus, the fifth state S5 deletes the partial password P1.

The state diagram continues in the sixth state S6 after deletion. There, it is verified if, apart from the master password, other abridged passwords, meaning partial passwords, are still available in the list LIS. If this is true, the right state diagram is continued over path Y in the third state S3, otherwise the sequence will be ended in an end state ENO. After reaching the end state ENO, the user can only change the workstation computer into the active state by means of the master password.

If the sequence is continued in the third state S3, a new time period TP, 10 minutes for example, will be selected. During this time period, the user can change the workstation computer into the active state with the aid of the abridged passwords, meaning the partial passwords P2 and P3. If this does not occur, after the time period of 10 minutes has passed, the partial password P2 is deleted from the list. Afterwards another time period is defined, 20 minutes for example, within which the user can unlock the workstation computer using the partial password P3 or the master password. If this does not occur, after 20 minutes has lapsed in the fifth state, the partial password P3 is deleted from the list and the process diagram ends in the end state ENO after verification by the sixth state S6 has occurred, since only the master password and no partial password is available in the list. Thereby, within a time span of 5+10+20=35 minutes, the user has the possibility to unlock the workstation computer with the abridged passwords, meaning partial passwords. Afterwards, the workstation computer can only be changed into the active state using the master password.

Contrary to the example, embodiments of the invention are not limited to the aforementioned values for the number of partial passwords or master password. Often, the master password comprises more than 10 characters. In addition, a minimum number of characters for the partial password can be predefined, for example, at least 3 characters, in order to therefore have a basic level of security when choosing a password. Furthermore, the partial passwords do not have to be related strings of characters of the master password or can be formed in any way, even independent of the master password. For example, when querying the partial password by means of the program PRG, certain positions of the master password can be queried, for example, the second and the fourth character position.

The partial passwords can be formed as a related string of characters of the master password since, by this, the user only has to memorize the master password since the partial passwords are strings of characters of the master password. It is especially beneficial if the related string of characters begins with the character which corresponds to the first character of the master password. By means of this, when inputting the password, the user can enter the characters analogous to the sequence of characters of the master password, whereby the input password is compared with the passwords and partial passwords that are stored in the list after entering each new character. Thereby, the user must only memorize the master password independently of the partial passwords stored in the list, whereby the active state is achieved after the user has input at least a number of characters of the master password that corresponds to the smallest number of characters of one of the partial passwords in the list. This makes comfortable operation and quickly changing the state from the inactive to the active state possible.

In order to securely store the master password and/or the partial passwords in the list, these can be coded with the aid of a hash function [1]. In order to increase security, individual random values can also be added for each partial password and master password within the scope of the coding process by the hash function, which is known as “salt” in the English language. Since hash coding often generates coded partial passwords that are identical in length, in addition to saving the coded partial password, the related number of characters and, if required, the related random value can also be stored in the list in sequence.

In order to generate partial passwords, the valid password is known in plain text to the second state S2, since it has been positively verified with regard to the entries in the list; if required, the verification would take place after hash coding using the random value of the entered password. From this, at least a partial password can be generated and stored in the list. Since the list starting with the partial password, which has the smallest number of characters, is reduced, starting from the current password, which has been positively verified, one or a plurality of partial passwords can be generated. Deleting all partial passwords and starting an entirely new list are therefore not necessary.

In addition to the individual setting of the time period, up until at least one partial password is deleted, the time period can also be determined depending on entropy of the partial passwords stored in the list with the shortest number of characters. If the partial password is “aaa”, the entropy is smaller than in the case of a partial password “a$9”. In the first case, a smaller value for the time span and, in the second case, a larger value is specified, for example one minute in contrast to eight minutes. In general, the entropy describes an extent for the average information content or also information density of the respective password/partial password.

Furthermore, the time can be defined depending on (i) a position as well as on (ii) a distance of the user or of the device from a location. If the user or the device is within the near proximity, for example, in a building, the individual values for the time period can be selected to be greater than is the case when the user or the device are a plurality of kilometers away from each other, for example the distance is detected via a radio-cell positioning system of a mobile communication network. In the latter case, the reduction of the value of the time period makes it possible that a very secure password for changing the operational state is required within a shorter time and therefore, the security thereof can be increased. For example, this enhancement can be implemented with a multiplicative factor. That means if the user or the device are in near proximity, the factor by which the time spent is multiplied is two, for example, and 0.25 at a far range for example. In the first variant of this enhancement, the time period can be chosen depending on the position of the device. If the device is located in an area that is only accessible via access control, for example a vault, greater time periods can be chosen as is the case when the device is located within a public space, for example if the device is a PC with Internet access in an Internet café. The positioning can be carried out via common positioning systems such as GPS (Global Positioning System) or via mobile communications.

In the above exemplary embodiment, the passwords/partial passwords are saved in the list and, after a time period has lapsed, one or a plurality of partial passwords with a shortest length, meaning a lowest number of characters is/are deleted in order, by means of this, for only passwords/partial passwords with a number of characters larger than the shortest length to be used when logging in. In an alternative embodiment, initially, all passwords or partial passwords are stored in the list LIS. Furthermore, a marking is added in the list that indicates which passwords are not permitted and/or inadmissible for the next login. In an alternative embodiment, after a time period has passed, no password/partial password is deleted, but the marking in the list is updated in such a way that the marking indicates that only one or a plurality of partial passwords are immediately no longer accepted, which had been accepted up until that point. The following example shows this process. The list contains the following entries, wherein the password P4 is the master password the other passwords derive from.

Number of the Partial

| list entry | password | Content | Number of characters |
|---|---|---|---|
| 1 | P1 | a | 1 |
| 2 | P2 | a! | 2 |
| 3 | P3 | a!8 | 3 |
| 4 | P4 | a!8# | 4 |

Initially, the marking indicates list entry 1, whereby the passwords P1 to P4 are permissible passwords for carrying out the change of state. After the time period has lapsed, the marker is set to 2. At that time, only the passwords of P2 to P4 are permissible. After another time period expires, the marking is set to 3, whereby only the passwords P3 and P4 are accepted as permissible passwords when logging in. Finally, after another time period has expired, the marking is placed onto P4, whereby only the master password, meaning the password with the most characters, is permissible in order to bring about the change of state. After a change of state from the second state into the first state has taken place after some time later, the marking is set to the value 1 again and the first time period is started that changes the marking to the next value after lapsing. As an alternative, after achieving a change of the device's state into the second state, the marking can also be set to the same value that has the partial password with the smallest length. The first time period can generally be started already after reaching the second operational state or after reaching the first operational state, for example, with the aid of a timer.

Embodiments of the invention have been illustrated in the exemplary embodiment on the basis of a password query to change the state of the workstation computer by the user. In general, the user of the device can be another device in a manufacturing facility, wherein the other device for the exchange of data, e.g. control commands or measurement readings, must initially authenticate itself by means of the password for the device, and, only after successful authentication has taken place, can the data be transmitted. Due to the authentication, the device is changed from the first operational state to the second operational state. Thereby, using abridged passwords, meaning partial passwords, the authentication process can be accelerated since the complexity of carrying out the authentication process on the device side is made considerably easier, for example, by means of the program PRG and the list LIS.

Embodiments of the invention can be implemented by a device VOR—see FIG. 3—which is designed for the provision of at least one password P1, P2, P3, P4 for changing the state of a device COM from a first operational state into a second operational state by means of inputting the password P1, P2, P3, P4, wherein a first unit E1 is designed to set a number of characters of the password P1, P2, P3, P4 depending on a time duration ZD of the first operational state of the device COM. The device can furthermore have a second unit E2 that is designed in such a way that at least one of the aforementioned enhancements to the method can be implemented and executed. The first and the second unit can be implemented in software, hardware or a combination of software and hardware. By means of this, the individual steps of the method can be saved in a machine-readable code on the memory unit, wherein the code can be read by a processor unit connected to a memory unit. The processor unit can be designed with a first and second unit as well as with other units by means of a bus BUS for the exchange of data, such as communication messages for exchange with another device or to take on password entry.

### LITERATURE

[1] “hash-function”, see http://en.wikipedia.org/wiki/Hash_function

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for the provision of at least one password for changing the state of a device from a first operational state into a second operational state by inputting the password, wherein a number of characters of the password are set in accordance with the time duration of the first operational state of the device.

2. The method as claimed in claim 1, wherein the number of characters is set to be larger as the time duration increases.

3. The method as claimed in claim 1, wherein
(a) after successfully inputting the password with a first number of characters, a list with at least one partial password is created, wherein the at least one partial password has a subset of characters of the password and a number of characters of the at least one partial password is less than or equal to the first number,
b) due to the list, a lot of passwords for changing the state of the device from the first operational state to the second operational state are provided.

4. The method as claimed in claim 3, wherein, after a time period of the time duration has passed, whereby the time period represents a span of time after carrying out a modification to the list, one or a plurality of partial passwords are deleted from the list.

5. The method as claimed in claim 4, wherein, after deleting at least one partial password, the time period is increased or decreased up until the next modification of the list.

6. The method as claimed in claim 5, wherein a value of the time period is generated at least based on an entropy of the same partial password of the list that has the smallest number of characters.

7. The method as claimed in claim 4, wherein a value for the time period is set based on a distance or specifying a position, wherein the position is a geographical position of the device.

8. The method as claimed in claim 4, wherein the method is prevented once the list contains only a single password.

9. The method as claimed in claim 3, wherein the list with a plurality of partial passwords is created so that one of the partial passwords with a small number of characters is completely contained in another one of the partial passwords with a number of characters larger than the small number of characters.

10. The method as claimed in claim 3, wherein the at least one partial password is saved in the list with the help of a hash-coding method in sequence and in a coded manner.

11. The method as claimed in claim 10, wherein, when coding the partial password, a random value is furthermore taken into account and the random value is additionally saved in the list in sequence.

12. A device for the provision of at least one password for changing the state of a device from a first operational state into a second operational state by inputting the password, wherein a first unit to set a number of characters of the password depending on a time duration of the first operational state of the device.

13. The device as claimed in claim 12, wherein a second unit that is designed in such a way that at least one of the method steps in accordance with:
a method for the provision of at least one password for changing the state of a device from a first operational state into a second operational state by inputting the password, wherein a number of characters of the password are set in accordance with the time duration of the first operational state of the device,
wherein the number of characters is set to be larger as the time duration increases
can be implemented and executed.
